(19) United States
(12) Patent Application Publication
(10) Pub. No.: US 2008/0099161 A1
(43) Pub. Date: May 1, 2008

(54) Positioning drum for a Venetian blind

(76) Inventor: Tai-Ping Liu, LLung-Ching Hsiang (TW)

Correspondence Address: PATENTTM.US, P. O. BOX 82788, PORTLAND, OR, 97282-0788, US

(21) Appl. No.: 11/538,797

(22) Filed: Oct. 4, 2006

(51) Int. Cl. E06B 9/307

(52) U.S. Cl. 160/177 R

(57) ABSTRACT

A positioning drum for a Venetian blind has a cylinder, two sidewalls and a cord plate. The cylinder extends longitudinally and has two sides and an outer surface. The sidewalls are curved, extend respectively from the sides of the cylinder and each sidewall has a first edge. The cord plate is mounted between the first edges of the sidewalls and has a notch, two mounting holes, two channels and two secure posts. The notch is defined in the cord plate and has two longitudinal edges and a bottom. The mounting holes are defined in the cord plate near the bottom of the notch. The channels communicate respectively with the mounting holes and the notch. The secure posts are formed respectively on the longitudinal edges of the notch and each secure post has a distal end. The distal end extends toward and bars one of the channels.

### BACKGROUND OF THE INVENTION

1. Field of Invention

The present invention relates to a Venetian blind, and more particularly to a positioning drum for a Venetian blind that can hold cords of the Venetian blind securely.

2. Description of the Related Art

With reference to FIG. 6, a conventional positioning drum for a Venetian blind has a hollow cylinder, two sidewalls (80) and two hooks (81). The hollow cylinder has an outer surface and two sides. The sidewalls (80) are curved and extended respectively from the sides of the hollow cylinder and each sidewall (80) has a connecting edge connected to the cylinder. The hooks are mounted on the outer surface of the hollow cylinder between the connecting edges of the sidewalls (80).

When the conventional positioning drum is in use, a control rod is inserted into the hollow cylinder of the conventional positioning drum for rotating the conventional positioning drum and the conventional positioning drum is mounted rotatably in a base. Two cords (90) are connected to slats of the Venetian blind and each cord (90) has an end and an enlarged tag (91). The ends of the cords (90) are mounted respectively in the hooks (81). The enlarged tag (91) is attached to the end of each cord (90) to prevent the ends of the cords (90) from escaping from the hooks (81). When the conventional positioning drum is rotated by the control rod, the cords (90) are moved up or down to change the angular position of the slats of the Venetian blind.

However, the conventional positioning drum has following disadvantage. The end of each cord (90) is held by one of the hooks (81) with the enlarged tag (91) on the cord (90), but the securing effect between the hook (81) and the enlarged tag (91) is not enough. When the rotating force applied to the conventional positioning drum is too large, the cords (90) may escape easily from the conventional positioning drum and the Venetian blind is unable to be operated.

To overcome the shortcoming, the present invention provides a positioning drum for a Venetian blind to mitigate or obviate the aforementioned problems.

### SUMMARY OF THE INVENTION

The primary objective of the present invention is to provide a positioning drum for a Venetian blind that can hold cords of the Venetian blind securely.

The positioning drum for a Venetian blind in accordance with the present invention has a cylinder, two sidewalls and a cord plate. The cylinder extends longitudinally and has two sides and an outer surface. The sidewalls are curved, extend respectively from the sides of the cylinder and each sidewall has a first edge and a second edge. The cord plate is mounted between the first edges of the sidewalls and has a notch, two mounting holes, two channels and two secure posts. The notch is defined in the cord plate and has two longitudinal edges and a bottom. The mounting holes are defined in the cord plate near the bottom of the notch. The channels communicate respectively with the mounting holes and the notch and each channel has a width. The width of each is increased gradually toward the notch. The secure posts are formed respectively on the longitudinal edges of the notch and each secure post has a distal end. The distal end extends toward and bars one of the channels.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a positioning drum for a Venetian blind in accordance with the present invention;

FIG. 2 is an operational perspective view of the positioning drum in FIG. 1 with the cords of the Venetian blind being mounted in the positioning drum;

FIG. 3 is a cross sectional side view of the positioning drum in FIG. 2;

FIG. 4 is a top view of the positioning drum in FIG. 2;

FIG. 5 is an exploded perspective view of the positioning drum in FIG. 1 with the taps of the Venetian blind; and

FIG. 6 is a perspective view of a positioning drum for a Venetian blind in accordance with the prior art.

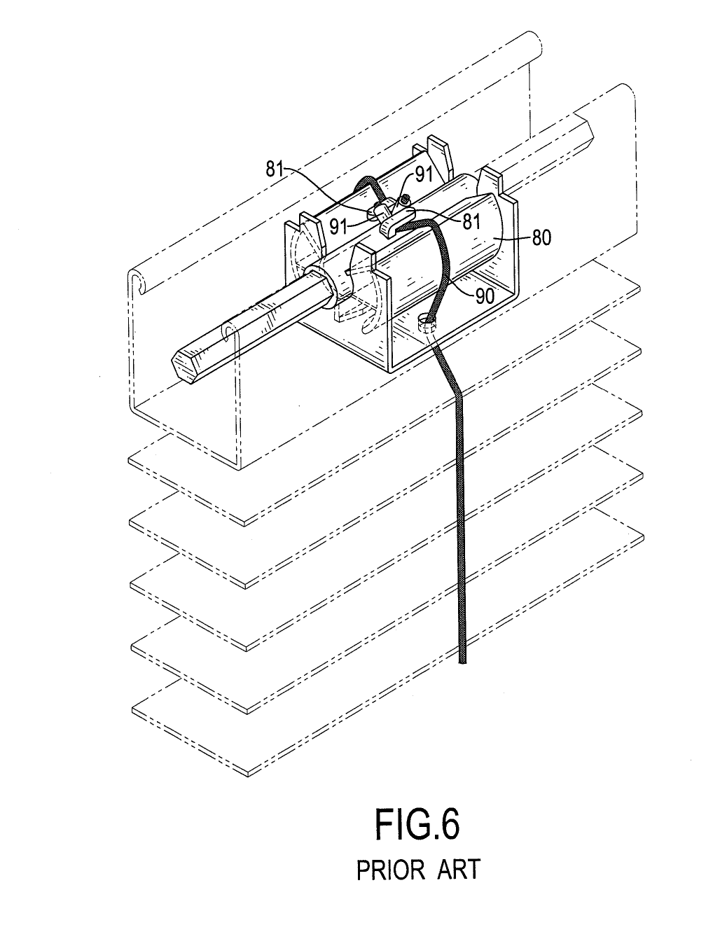

### DETAILED DESCRIPTION OF THE INVENTION

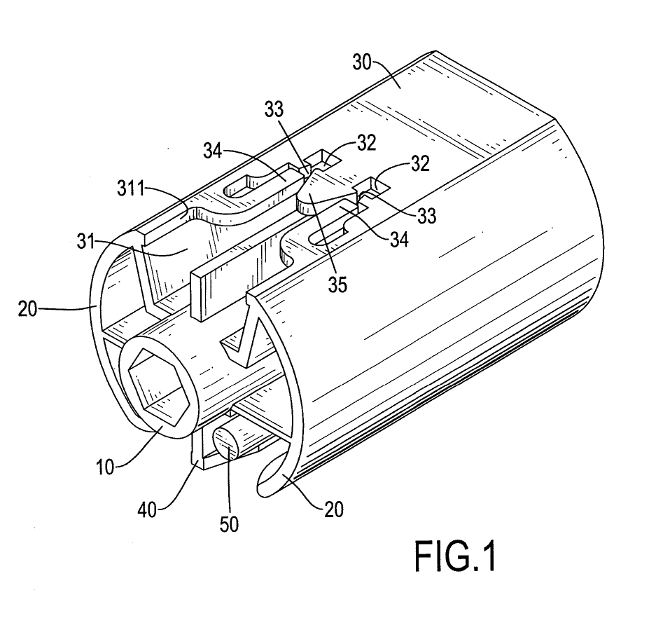

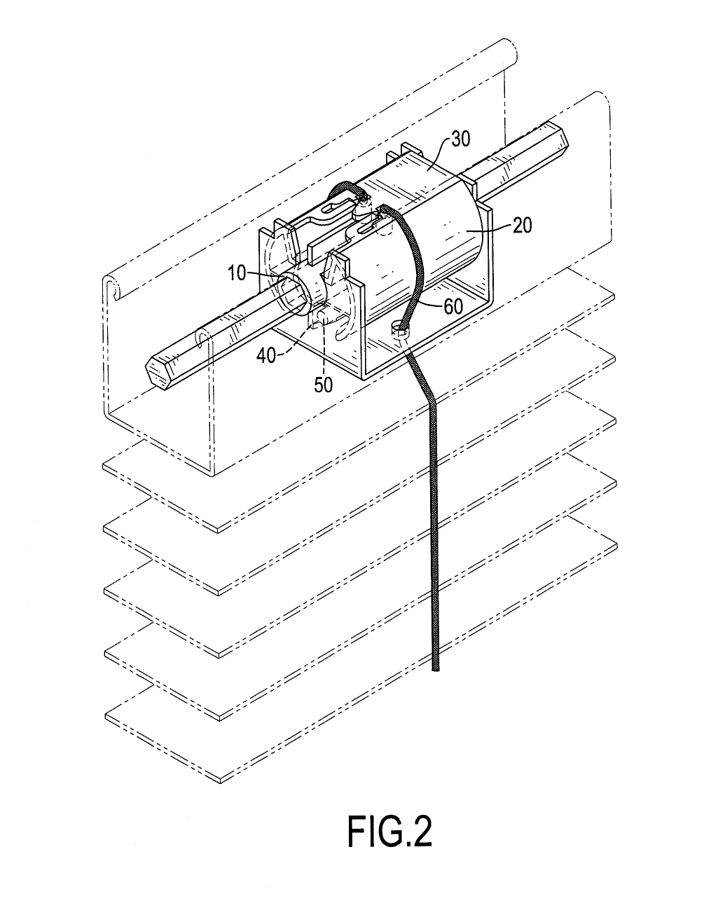

With reference to FIGS. 1 and 2, a positioning drum for a Venetian blind having two cords (60) or two taps (70) in accordance with the present invention comprises a cylinder (10), two sidewalls (20), a cord plate (30), a tap plate (40) and two inserting posts (50). The cylinder (10) is hollow, extends longitudinally and has two sides, two ends, a length and an outer surface.

The sidewalls (20) are curved and extend respectively from the sides of the cylinder (10) and each sidewall (20) has a first edge, a second edge, two ends and a length. The length of the sidewalls (20) is shorter than the length of the cylinder (10) and each end of the cylinder (10) is protrudent relative to the corresponding ends of the sidewalls (20).

The cord plate (30) is mounted between the first edges of the sidewalls (20) and has a notch (31), two mounting holes (32), two channels (33), two secure posts (34) and an optional guide block (35). The notch (31) is defined in the cord plate (30) and has two longitudinal edges (311) and a bottom. The mounting holes (32) are defined through the cord plate (30) near the bottom of the notch (31). The channels (33) communicate respectively with the mounting holes (32) and the notch (31) and each channel (33) has a width. The width of each channel (33) is increased gradually toward the notch (31) so one of the cords (60) of the Venetian blind is easy to enter the corresponding mounting hole (32) through the channel (33). The secure posts (34) are L-shaped, are formed respectively on the longitudinal edges (311) of the notch (31) and each secure post (34) has a distal end. The distal end of each secure post (34) extends toward one of the channels (33) so the distal end of the secure post (34) can pivot to bar or open the channel (33). The guide block (35) is generally triangular and is mounted between the secure posts (34) and has two inclined edges. The cords (60) of the Venetian blind can enter the channels (33) easily along the inclined edges of the guide block (35).

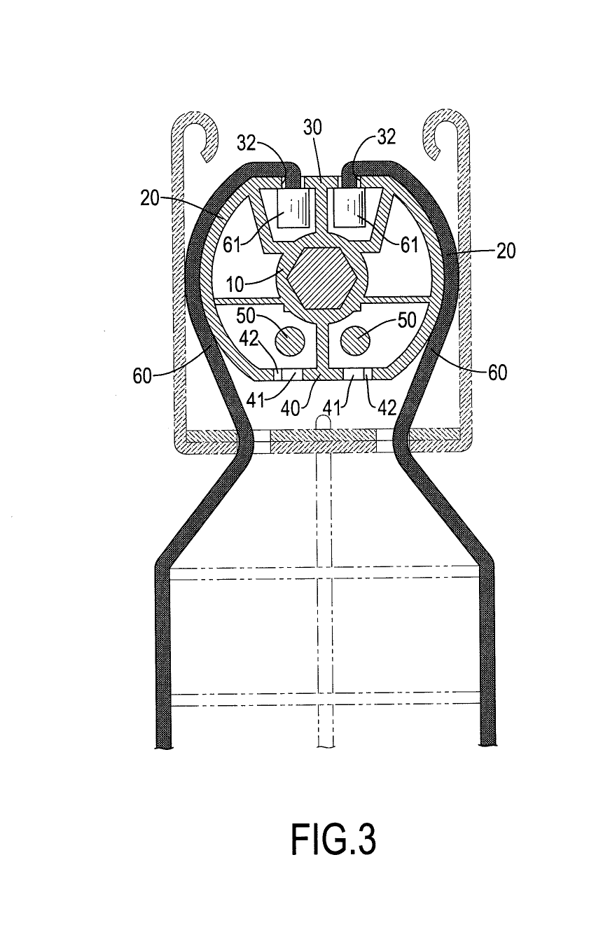

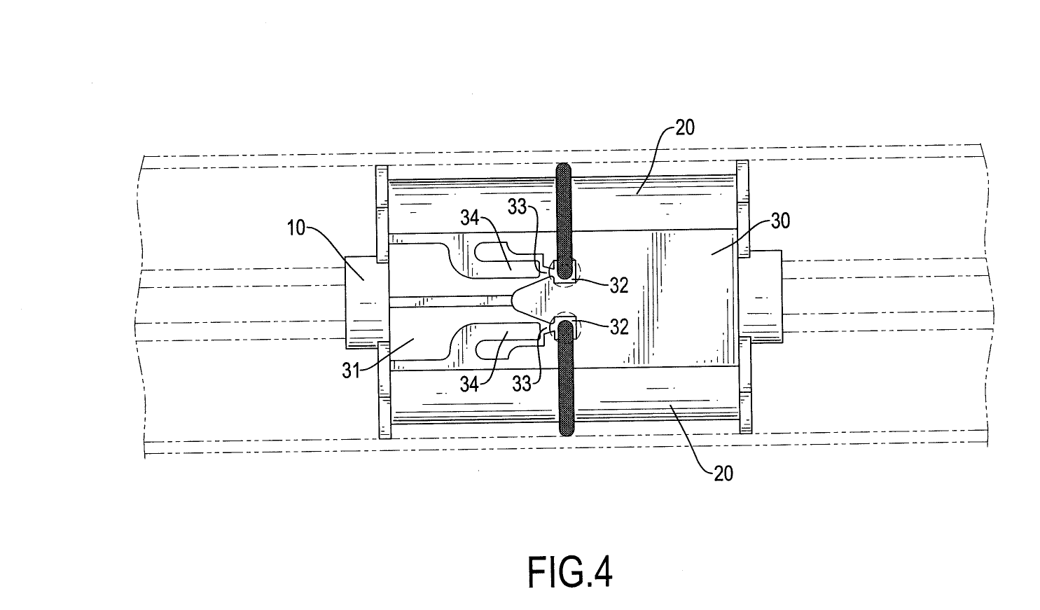

With further reference to FIGS. 3 and 4, the cords (60) of the Venetian blind are connected to slats of the Venetian blind and each cord (60) of the Venetian blind has an end and an enlarged tag (61). The enlarged tag (61) is attached firmly to the end of the cord (60) and is mounted in one of the mounting holes (32). When the cord (60) enters one of the channels (33), the corresponding secure post (34) is pushed laterally by the cord (60) and the distal end of the secure post (34) pivots toward the corresponding longitudinal edge (311) to open the channel (33). After the cord (60) enters the channel (33), the distal end of the secure post (34) is repositioned by the resilient force of the secure post (34) and the channel (33) is barred again to prevent the cord (60) from escaping from the channel (33). Accordingly, the cords (60) of the Venetian blind are mounted respectively and securely in the mounting holes (32) of the positioning drum.

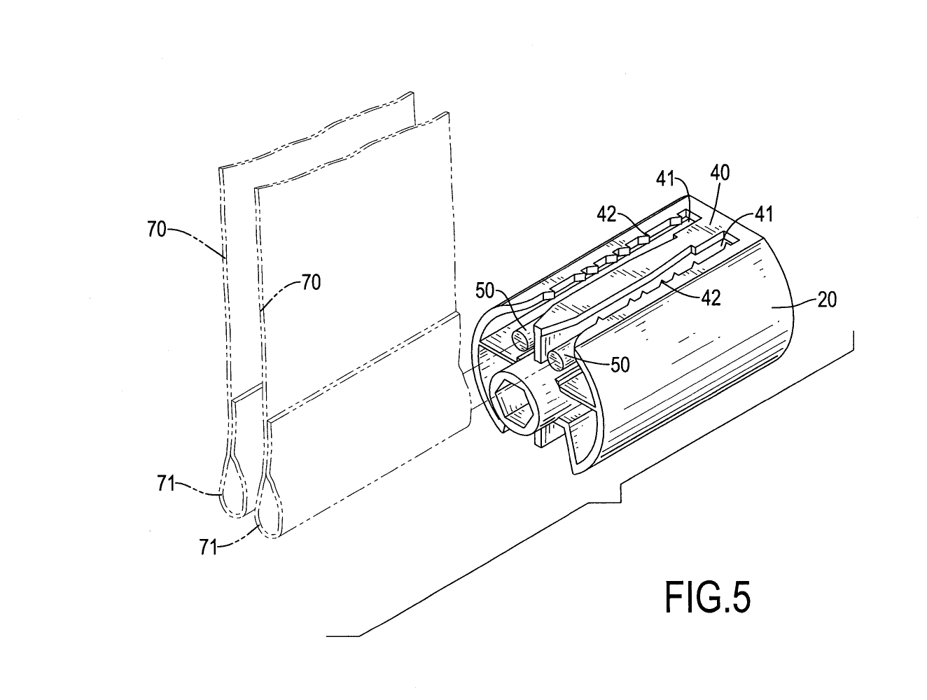

With further reference to FIG. 5, the tap plate (40) is mounted between the second edges of the sidewalls (20) and has two recesses (41) and multiple teeth (42). The recesses (41) are defined longitudinally in the tap plate (40) and each recess (41) has an outer edge. The teeth (42) are formed respectively on the outer edges of the recesses (41) at different intervals to retain taps (70) of the Venetian blind securely.

The inserting posts (50) extend longitudinally and each inserting post (50) is mounted between one of the recesses (41) in the tape plate (40) and the cylinder (10).

The taps (70) of the Venetian blind are connected to the slats of the Venetian blind, extends respectively through the recesses (41) in the tap plate (40) and each tap (70) has an end and a loop (71). The loop (71) is formed on the end of the tap (70) and is inserted by one of the inserting posts (50). The taps (70) are held in the recesses (41) by the teeth (42) and may not escape from the recesses (41) easily.

When the positioning drum in accordance with the present invention is in use, a control rod is inserted into the cylinder (10) and the positioning drum is mounted rotatably in a base. When the positioning drum is rotated by the control rod, the cords (60) or taps (70) are moved up or down to change the angular position of the slats of the Venetian blind.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A positioning drum for a Venetian blind having
a cylinder extending longitudinally and having
two sides;
two ends;
a length; and
an outer surface;
two sidewalls being curved, extending respectively from the sides of the cylinder and each sidewall having
a first edge; and
a second edge; and
a cord plate being mounted between the first edges of the sidewalls and having
a notch being defined in the cord plate and having
two longitudinal edges; and
a bottom;
two mounting holes being defined through the cord plate near the bottom of the notch;
two channels communicating respectively with the mounting holes and the notch and each channel having
a width being increased gradually toward the notch; and
two secure posts being formed respectively on the longitudinal edges of the notch and each secure post having
a distal end extending toward and barring one of the channels.

2. The positioning drum for a Venetian blind as claimed in claim 1, wherein
the cord plate further has a guide block; and
the guide block is triangular and is mounted between the secure posts.

3. The positioning drum for a Venetian blind as claimed in claim 2, wherein the secure posts are L-shaped.

4. The positioning drum for a Venetian blind as claimed in claim 3 further having
a tap plate being mounted between the second edges of the sidewalls and having
two recesses being defined longitudinally in the tap plate and each recess having an outer edge; and
multiple teeth being formed respectively on the outer edges of the recesses; and
two inserting posts extending longitudinally and each inserting post being mounted between one of the recesses in the tape plate and the cylinder.

5. The positioning drum for a Venetian blind as claimed in claim 4, wherein
the teeth of the tap plate are formed respectively on the outer edges of the recesses at different intervals.

6. The positioning drum for a Venetian blind as claimed in claim 1, wherein the secure posts are L-shaped.

7. The positioning drum for a Venetian blind as claimed in claim 1 further having
a tap plate being mounted between the second edges of the sidewalls and having
two recesses being defined longitudinally in the tap plate and each recess having an outer edge; and
multiple teeth being formed respectively on the outer edges of the recesses; and
two inserting posts extending longitudinally and each inserting post being mounted between one of the recesses in the tape plate and the cylinder.

8. The positioning drum for a Venetian blind as claimed in claim 7, wherein
the teeth of the tap plate are formed respectively on the outer edges of the recesses at different intervals.

9. The positioning drum for a Venetian blind as claimed in claim 1, wherein
each sidewall has two ends and a length;
the length of each sidewalls is shorter than the length of the cylinder; and
each end of the cylinder is protrudent relative to corresponding ends of the sidewalls.

10. The positioning drum for a Venetian blind as claimed in claim 1, wherein the cylinder is hollow. .
